(19) United States
(12) Patent Application Publication
(10) Pub. No.: US 2012/0125829 A1
(43) Pub. Date: May 24, 2012

(54) DESALINATION INTAKE SYSTEM WITH NET POSITIVE IMPACT ON HABITAT

(76) Inventor: Paul Steven Wallace, Katy, TX (US)

(21) Appl. No.: 13/307,933

(22) Filed: Nov. 30, 2011

Related U.S. Application Data
(63) Continuation-in-part of application No. 13/118,326, filed on May 27, 2011.
(60) Provisional application No. 61/350,734, filed on Jun. 2, 2010.

(51) Int. Cl. C02F 9/14; C02F 1/00; C02F 103/08

(52) U.S. Cl. 210/170.11

(57) ABSTRACT

An environmentally supportive seawater intake system includes a first filtering system in communication with raw seawater for providing a flow of seawater and a second filtering system is also in communication with the first filtering system for providing intake water to a downstream system while minimizing negative impact on the seawater environment and organic species living therein.

### CROSS-REFERENCE TO RELATED APPLICATION

This application is a continuation in part of U.S. patent application Ser. No. 13/118,326, filed on May 27, 2011, and entitled: ““DESALINATION INTAKE SYSTEM WITH NET POSITIVE IMPACT ON HABITAT”, which is a completion of the U.S. Provisional Patent Application, Ser. No. 611350,734, filed on Jun. 2, 2010 by the inventor hereof, and entitled: “DESALINATION INTAKE SYSTEM WITH NET POSITIVE IMPACT ON HABITAT”. This application claims full priority based both the application Ser. No. 13/118,326 and the provisional application No. 611350734, which are incorporated in their entirety herein by reference.

### BACKGROUND

1. Field of the Invention

The invention is generally related to intake systems for seawater desalination systems and is specifically directed to a desalination intake system having a net positive impact on habitat.

2. Discussion of the Art

Fish and larvae entrapment and entrainment losses are a key environmental issue for desalination plants. Desalination plants are often located in ecologically sensitive coastal estuaries. The juvenile fish larvae, which are abundant in these waters, are killed when they are entrained or entrapped in desalination plant intake systems.

Screened intake systems have been developed for power plants that reduce entrainment and entrapment, but these cannot always be successfully applied at industrial waterfront sites. These sites are optimal locations for large scale desalination plants due to the large demand for high quality water. In addition, even the best screen system with fish return capability is only able to reduce entrainment by 85-90% versus an unscreened open ocean intake. This still results in a significant loss of fish and larvae due to the high concentration of sea life in the near shore environment.

Travelling screens with fine mesh (0.5 mm) have been used in once through seawater cooled power plants. These travelling screens achieve about an 85% removal efficiency. However, these systems require a fish return system that routes the recovered fish and larvae away from the intake system. For once through power plant cooling water, the fish and larvae can be routed to the discharge cooling water or a separate fish channel. These are typically located a significant distance away from the intake to prevent re-ingestion of the discharge cooling water or fish.

Once through power plants use large flows and low temperature rises (about 10° F.). Thus, the returned fish and larvae can survive in the discharge cooling water, or in a fish discharge channel, which is near the cooling water discharge.

Desalination plants have a discharge stream that has a high brine concentration. In addition it may contain anti-scalant and water treating chemicals. Any returned fish or larvae must be discharged away from the inlet and away from the discharge line. This makes placement of the intake, discharge and fish return especially difficult in an industrial area where seafront acreage is limited. Intake and outfall pipelines have been used; but, these are expensive and may interfere with navigation (dredged ship channels).

Travelling screens also have a high mortality rate for fish and larvae impinged on the screen and subsequently returned. Overall mortality rates of about 50% are typical for Gulf of Mexico water temperatures, even for modified travelling screens with fish buckets. The stress of impingement and reduced oxygen content in the water cause this high mortality.

Angled screens with sweeping water flow to a bypass fish channel have been effective in reducing mortality in river applications. The sweeping flow and bypass channel allow the fish and larvae to pass by the face of the screen without becoming impinged. However, typical seawater sites have alternating weak tidal currents, which are insufficient to sweep the fish by the face of the screen.

Wedgewire passive screens have been proven to be about 85•90% effective in removing fish and larvae from seawater intakes. However, in order to achieve this effectiveness, the following conditions must be met:

1) Small opening size (about 0.5 mm)

2) Slow velocity through the opening (about 0.5 ft/s)

3) Significant sweep velocity across the face of the screen (>1 ft/s)

The first two conditions require significant screen surface area. For large desalination plants, this can be impractical due to site restrictions. This is especially true for industrial or ship channel locations where waterfront real estate is limited.

The third condition also is difficult to achieve in seawater conditions since tidal currents are alternating. Depending on location, the tidal currents may not reliably generate the sweeping velocities needed to prevent entrapment on the screen.

Subsurface intakes use horizontal or vertical beach wells to supply seawater to the desalination plant. Subsurface wells are effective at preventing entrainment and entrapment since the sea floor acts as an effective filter, thereby removing essentially all sea life. However, subsurface intakes require a high porosity sea bed to provide a sufficient flow of seawater to support a commercial desalination plant. At many locations the sea bed porosity is too low to support a commercial desalination unit. In addition, there is a long term risk of damaging coastal aquifers with salt water intrusion.

Many of the world's estuaries are stressed due to reduced fresh water flows. On the U.S. Gulf Coast, this has led to oyster reef habitat destruction. In addition to producing oysters, oyster reefs provide habitat for juvenile fish. Oysters are attacked by parasites (dermo-protozoan, oyster drill-snail) when insufficient spring flood freshwater pulses enter the estuary. Upstream dams on the rivers feeding the estuaries are typically constructed to capture the spring floodwater for agricultural, municipal, and industrial use. Although minimum flows are supplied to the estuary on a year round basis, the cleansing effect of a spring flood event is no longer available.

Ship channels have also been dredged through estuarial bays. This facilitates commerce, but can increase estuary turbidity and channel tidal flows. Fertilizer runoff also enters the estuary in higher concentrations due to the reduced inlet water flows. The reduced tidal flows, higher fertilizer concentration, and higher turbidity can lead to hypoxic conditions in the estuary. This leads to additional oyster reef habitat destruction.

It remains, therefore, desirable to provide a seawater intake system that can be employed in commercial desalination systems near shorelines where the fresh water is required with a minimum of environmental impact on the fragile sea life dependent upon the coastal waters.

### SUMMARY OF THE INVENTION

Embodiments of this invention involve an integrated intake and reef system which feeds seawater to a desalination plant, but has a net positive impact on the adjacent seawater habitat.

This is achieved by an intake system with the following attributes:
A desalination intake system with minimal (about 10%) impingement and entrainment losses; and
An optimized reef ecosystem.

In the intake system of the subject invention seawater flows at low velocity (about 0.5 ft/s) through a grating into an inlet raceway. A baffle at the top of the grating prevents fish and larvae rich surface water from entering the raceway. The bottom of the grating is located above the bottom to prevent significant amounts of sediment from being entrained into the raceway.

Seawater in the raceway is accelerated in the raceway to about 1.5-2 ft/s. This can be achieved by providing the raceway with a smaller cross section than the inlet grating. This ensures that settling of sediment will substantially not occur in the raceway. Wedgewire screens with about a 0.5 mm gap, about a 0.5 ft/s through screen velocity and about a 1-2 ft/s cross flow/channel velocity are installed parallel to the flow direction in the raceway. A portion of the seawater in the raceway is pulled through the wedgewire screen. The combination of small opening size, low through screen velocity, and high cross flow screen outer surface velocity minimizes fish and larvae entrainment and entrapment on the screens.

Multiple wedge wire screens are used in series in the raceway channel. Under the optimized conditions in the raceway, the wedgewire screens typically entrain or entrap less than about 10% of the fish and larvae in the seawater.

The filtered seawater that is pulled through the screen is acidified to a pH of about 6.5 and is periodically disinfected with a biocide. The acidified and periodically disinfected seawater enters an enclosed sump and a submerged or sump pump is used to pump the seawater out of the sump to the desalination plant. The reduced pH and biocide prevent biological growth in the sump, pump and seawater pipeline to the desalination plant. The pumps and screen pressure drop maintain the sump level below the level in the raceway. This prevents backflow or leakage of disinfected seawater into the raceway.

An interlock system shuts off the acid and biocide injection if the level differential becomes too low.

The residual seawater containing the bulk of the fish and larvae exits the raceway and enters a rear transfer pond. The rear transfer pond is connected to two reef ponds each equipped with transfer pumps. These pumps are fish friendly pumps with proven low (<5%) mortality rates (fish friendly low speed impeller pump, Venturi jet pump, air lift pump). The transfer pumps are operated so that the residual seawater from the raceway is pumped into the reef that is down current from the inlet During times of slack tide or no cross flow tidal current, both transfer pumps are operated in parallel. A variable speed drive on the pumps or compressor (air lift system) provides transfer pump flow adjustment. An aerator located in the transfer pump plume aerates the water being transferred into the reef (not used for air lift pump).

In addition to a large raceway transfer pump, each reef is equipped with a smaller reef level control pump. The reef level control pump pumps water out of the reef into the rear transfer pond. This pump extracts seawater from the reef that is not receiving the flow from the raceway. This ensures a positive flow of seawater into the reef during all tidal conditions. This is important during outgoing tide conditions since the outlet of the non-circulating reef is up current from the outlet. Thus, any outgoing tidal flow from this reef could be re-ingested into the raceway inlet. With a Venturi pump, a reef level control pump is not required since reef water will backflow through the non-operating Venturi. A rotating disk may be required to limit the back flow through the Venturi, to ensure that the bulk of the flow into the rear transfer pond comes through the raceway.

The aerated water from the rear transfer pond enters the reef pond. The reef depth and bottom composition are selected to optimize fish, larvae, shellfish and micro-algae growth, maximizing reef productivity. In addition, periodic pulses of brackish desalinated water from the desalination plant, and clarified storm water runoff are used to flush the reef. This provides optimized water chemistry, and substrate conditions for reef productivity.

The subject invention is directed to an environmentally supportive seawater intake system having a first filtering system in communication with raw seawater for providing a flow of seawater into a raceway. A cross-flow filtering system is in communication with the seawater in the raceway. A portion of the raceway seawater is drawn through the cross-flow filtering system for delivery as intake water. The residual portion of seawater in the raceway continues to flow in the first direction and with the drawn water being separated and flowing along a different path to be used as intake water. An input device receives the intake water, and a recovery system receives and returns the first, residual portion to the sea environment.

In one embodiment of the invention, the seawater intake system is adapted for generating and transferring screened seawater to a desalination plant. An intake screen having an operable cross-section for screening and passing raw seawater for creating screened intake seawater is in communication with a raceway, wherein the operational cross-sectional area of the intake screen is larger than the operational cross-sectional area of the raceway, and wherein the flow rate through the raceway is approximately 1.5-2 times the flow rate through the intake screen. A cross flow screen is located in the raceway and in communication with the seawater in the raceway for permitting the flow of screened cross flow water in a direction which is in cross flow with the seawater in the raceway to create a first, residual portion of the seawater flowing in the direction of the raceway and a second, filtered portion of seawater flowing in a direction cross flow to the raceway. The system includes an intake flow system comprising of a sump for receiving the second portion of seawater and a pump for discharging the second portion of seawater into an intake port of the desalination plant. A recovery system receives and delivers the first, residual portion of seawater to a reef pond. The recovery system includes a transfer pond for receiving the first, residual portion of seawater, and a pumping system for pumping the first, residual portion of seawater from the pond into the reef pond.

### BRIEF DESCRIPTION OF THE DRAWINGS

FIG. 1 is a system overview of the seawater intake system of the subject invention.

FIG. 2 is an example of the intake structure for use in combination with the overall system, utilizing a low impact wedgewire seawater intake.

FIG. 3 is a diagrammatic view of an exemplary horizontal layout raceway and screen design in accordance with the subject invention.

FIGS. 4 and 5 are diagrammatic installation layouts of a typical system incorporating the subject invention, utilizing the horizontal raceway layout of FIG. 3

FIGS. 6 and 7 are diagrammatic views of an exemplary compact structure in accordance with the subject invention, utilizing a circulating intake structure in combination with a fish friendly pump.

FIGS. 8 and 9 are diagrammatic views of an exemplary compact structure in accordance with the subject invention, utilizing a circulating intake structure in combination with Venturi pump.

FIGS. 10 and 11 are diagrammatic views of an exemplary compact structure in accordance with the subject invention, utilizing a circulating intake structure in combination with an airlift.

FIG. 12 is a diagrammatic view of the low head recirculating aquaculture system used in connection with the configurations of FIGS. 6-11.

FIG. 13 is a diagrammatic view of an alternative embodiment with the raceway above sea level.

### DETAILED DESCRIPTION

The seawater intake system provides, but is not limited to, the following benefits:

1) Provides a desalination plant intake with a net overall improvement in the seawater habitat.

2) Has a small waterfront space requirement, and is suitable for installation on a commercial ship channel. The intake does not pose any hindrance to navigation.

3) Coupled with the high efficiency desalination design (about 99% desalination recovery), substantially reduces NPV in habitat mitigation costs versus an unscreened design or conventional travelling screen for about a 30 MGD desalination plant.

4) Adapts to alternating tidal flows during operation, and does not require a minimal tidal current velocity to sweep intake screens.

5) Requires a small reef size for full intake mitigation due to the high effectiveness of the intake screening (about 90%), and the high productivity of the reef (desalination flooding, optimized bottom and aeration). The small reef size enables it to be integral to the desalination plant.

The system of the subject invention permits:

1) Co-location of the oyster or coral reef and desalination intake. The desalination intake provides a constant flow of nutrients (seawater). Fish and larvae are swept by the intake screens into the reef, thereby minimizing entrainment and entrapment losses. The adjacent reef system also provides an effective recovery area for the juvenile fish, minimizing mortality.

2) Use of a raceway perpendicular to the waterfront. This simultaneously provides constant high cross flow velocity (independent of fluctuating tidal currents) and large surface area for effective use of wedgewire passive screens.

3) Use of hatchery type circulation devices (e.g. air lift pump, venture pump, or fish friendly impeller) to provide circulation in the intake system.

4) Use of dual reefs in alternating operation to prevent re-ingestion of fish and larvae rich reef effluent. This allows the intake system to be operated so that it dynamically adapts to any tidal conditions of a specific site.

5) Use of pulses of brackish (low quality) desalinated water to periodically flush the reef.

6) Use of air from the screen backflush system to aerate the water entering the reef system.

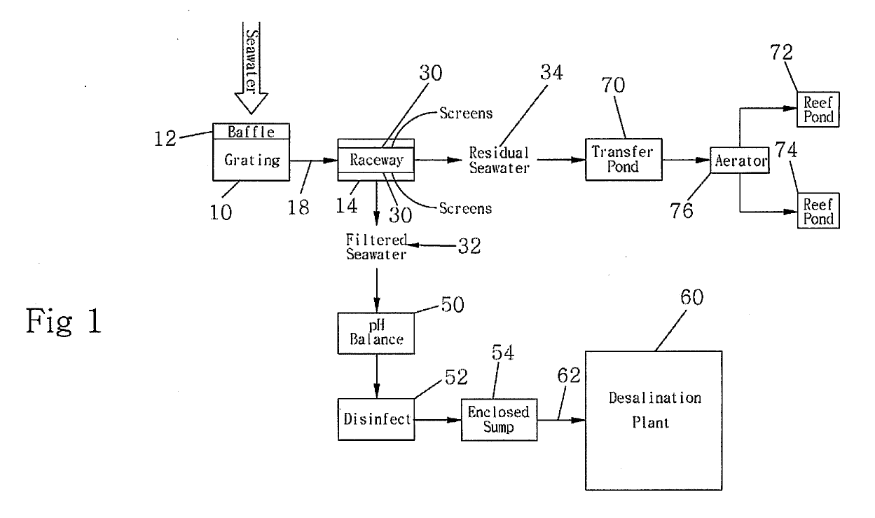

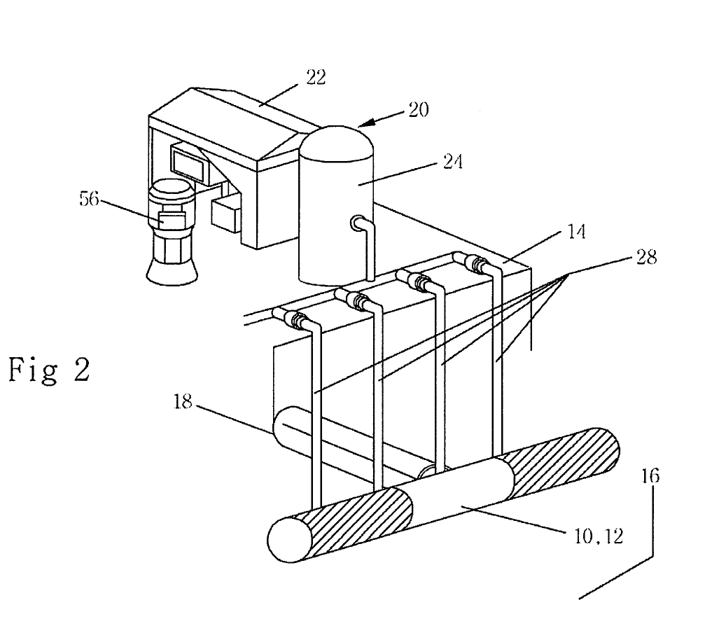

With specific reference to FIG. 1, the system includes a grated intake 10 with a baffle 12 upstream of the grated intake 10. Seawater passes through the baffle and through the grating and into a raceway 14. A typical intake grating system may be low impact seawater wedgewire intake system shown in FIG. 2. As there shown, the baffle and screen intakes are positioned above the sea floor to prevent significant amounts of sediment from being entrained into the raceway. The outlet of the grating system is coupled to a raceway module 14 via the conduit 18. An air blast system 20 permits self-cleaning of the grate and baffle system by using an air blast back flush and, at the same time, increases the dissolved oxygen in the intake system. As shown, the air blast system 20 comprises a compressor 22 and tank 24, connected to the intake grating system via a series of conduits 28. The compressor 22 and various pumps, as later described, are powered by a power supply 26, which may be, by way of example, a free standing generator.

The grated seawater is introduced into the raceway system 14 via the conduit 18. The raceway has a lower open cross-section than the grating system, whereby the seawater is accelerated as it passes from the grating system through the raceway. Typically, the flow of seawater through the grating system is about 0.5 ft/s, whereas the flow through the raceway is increased to between 1 ft/s and 2 ft/s. This ensures that settling of sediment will be minimized in the raceway.

As shown in FIG. 1, wedgewire screens 30 are positioned parallel to the flow of seawater through the raceway 14. The wedgewire screens 30 are sized to permit a cross flow through the raceway which is approximately 1.5-2 times the through flow. In a typical example, the through flow of seawater through the raceway will be approximately 1 ft/s to 2 ft/s and the cross flow through the screens 30 will be approximately 0.5 ft/s. As will be further described, a portion of the seawater (filtered seawater 32) in the raceway is drawn through the screens 30 for delivery as intake water. The residual seawater 34 is released to a transfer pond, as will be described.

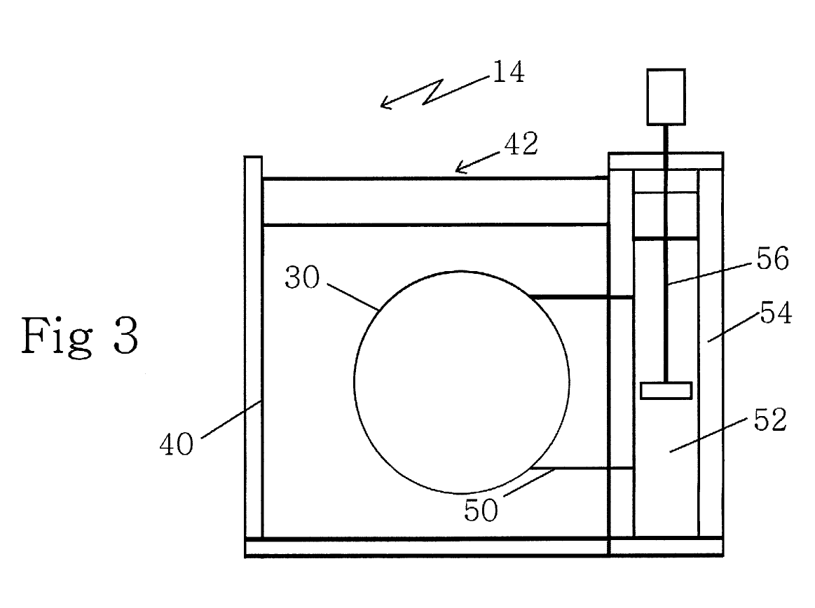

A diagrammatic view of a typical raceway 14 in accordance with the subject invention is shown in FIG. 3. As there shown, the seawater released by the grating system 10 is flowing perpendicular to the drawing. The raceway is a basically a walled container 40 having an open (or optionally closed) top 42, permitting the level of unfiltered seawater in the raceway to rise and fall with the tide. The unfiltered seawater in the raceway includes fish, larvae and the like. The screen(s) 30 extend the length of the raceway and run parallel to the flow of grated, filtered sweater. The cross flow at 1-2 ft/s and 30-60 MGD passes through the screen 30, by drawing seawater in the raceway into a sump 52. This permits a portion of the grated seawater in the raceway to be pulled through the wedgewire screen from the raceway container 40.

The combination of small opening size, low through screen velocity (about 0.5 ft/s) and high cross flow screen outer surface velocity minimizes the entrainment and entrapment of fish and larvae on the screens and in the water. Multiple screens may be used in series to further reduce the entrainment and entrapment of fish and larvae. It has been shown that less than 10% of the fish and larvae are entrained or entrapped using the raceway system of the subject invention.

As shown in FIGS. 1 and 3, the filtered seawater that passes through the screen 30 is introduced into a pH treatment system 50 and a periodically operated disinfecting system 52. Typically, the pH is acidified to 6.5 and the water is periodically disinfected with a biocide. The acidified and disinfected water enters an enclosed sump 52. A submerged pump or sump pump 56, powered by the power supply 26, pumps the seawater out of the sump 54 and to the desalination plant 60. The reduced pH and biocide prevent biological growth in the sump, pump and seawater pipeline 62 to the desalination plant 60. As shown in FIG. 3, the pressure drop through the screen 30 and by action of the pump 56 assures that the level in the sump is below the level in the raceway. This prevents backflow or leakage of disinfected seawater into the raceway. An interlock system may be provided to shut off the acid and biocide injection if the level or pressure differential becomes too low.

J Turning again to Fig. I, the residual seawater 34, which contains the bulk of the fish and larvae, exits the raceway and enters a rear transfer pond 70. In the example, the rear transfer pond is connected to two reef ponds 72 and 74, each equipped with transfer pumps, not shown. These pumps are commercially available fish friendly pumps with proven low <<5%) mortality rates, such as, by way of example, low speed impeller pumps, Venturi jet pumps, air lift pumps and the like. The transfer pumps are operated so that the residual seawater from the raceway is pumped into the reef that is down current from the inlet. During times of slack tide or no cross flow tidal current, both transfer pumps are operated in parallel. A variable speed drive on the pumps or compressor (air lift system) provides transfer pump flow adjustment. An aerator 76 located in the transfer pump plum aerates the water being transferred into the reef. The aerator is not required for an air lift pump system.

In addition to a large raceway transfer pump, each reef 72, 74 may be equipped with a smaller reef level control pump (not shown). The reef level control pump discharges water out of the reef into the rear transfer pond 70. This pump extracts seawater from the reef that is not receiving the flow from the raceway. This ensures a positive flow of seawater into the reef during all tidal conditions. This is important during outgoing tide conditions since the outlet of the non-circulating reef is up current from the outlet. Thus, any outgoing tidal flow from this reef could be re-ingested into the raceway inlet. With a Venturi pump, a reef level control pump is not required since reef water will backflow through the non-operating Venturi. A rotating disk may be utilized to limit the back flow through the Venturi, to ensure that the bulk: of the flow into the rear transfer pond 70 comes through the raceway.

The aerated water from the rear of the transfer pond 70 enters the reef ponds 72, 74. The reef depth and bottom composition are selected to optimize fish, larvae, shellfish and microalgae growth in accordance with known practices, maximizing reef productivity. In addition, periodic pulses of brackish desalinated water from the desalination plant 60, and clarified storm water runoff may be used to flush the reef. This provides optimized water chemistry and substrate conditions for reef productivity.

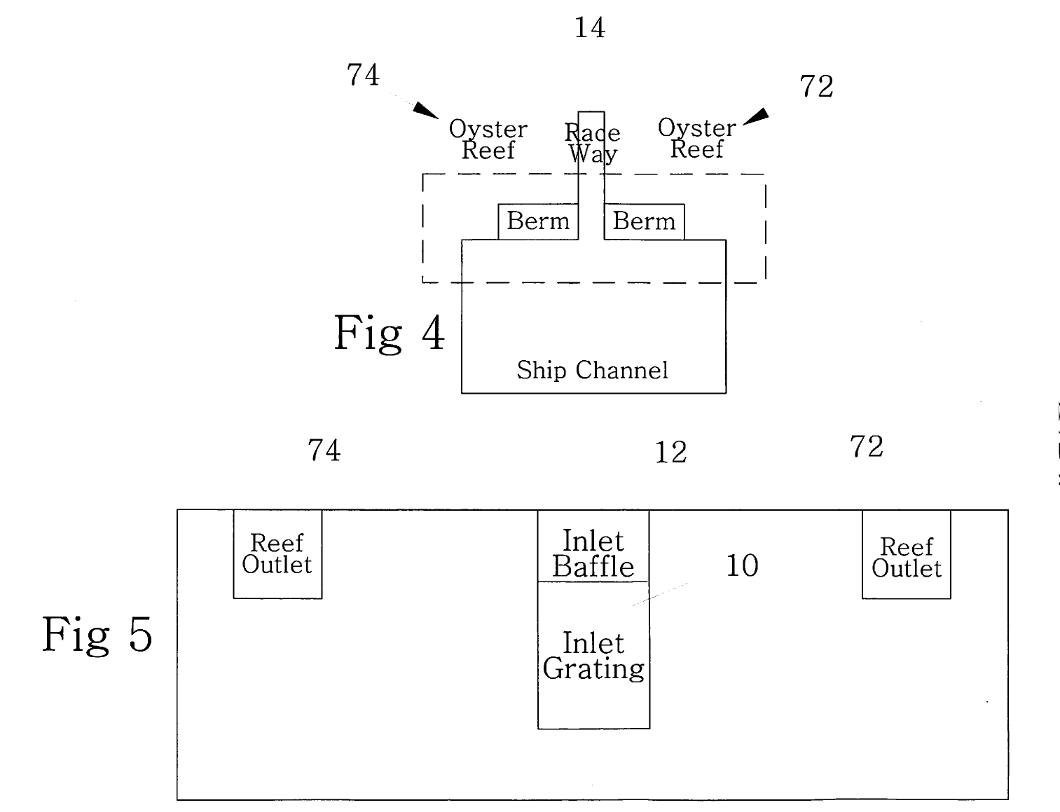

Plan and elevation views of the inlet and outlet design of a system incorporating the features of the subject invention are shown in FIGS. 4 and 5, respectively. As shown in FIG. 4, the raceway 14 is in communication with the berm 80 and the oyster reefs 72 and 74 are located outwardly therefrom. As shown in FIG. 5, the reef outlets are approximately 8 feet by 8 feet, and are positioned about 50 feet from the inlet baffle and grate system 10/12. The outlet flow velocity of the reefs is 0.4 to 0.7 ft/s and the inlet velocity of the baffle and grate system 10/12. Typically, the inlet baffle 12 extends 10 feet below the surface and the grate 12 extends 10 feet below that. The bottom of the grate 12 is approximately 15 feet above the seafloor. The inlet flow velocity of the baffle and grate system 10/12 is approximately 0.5 ft/s. The system of the present invention provides for lower salinity of the reef outlet above and separated from the inlet, and ensures that the lower density/salinity fish, larvae are in rich reef outlet water and not re-ingested.

The system minimizes entrainment and entrapment losses and minimizes floating debris ingestion. By placing the inlet grating 10 above the seafloor no ship channel bottom water is input into the desalination plant intake and the intake of silt is minimized.

A comparison of the attributes of the intake system of the subject invention with conventional mitigation and travelling screen systems follows:

| Intake with Wedgewire | | | |
|---|---|---|---|
| Screen and Internal Reef | Invention | No Mitigation | Travelling |
| ScreenDesal FlowMGD | 30 | 30 | 30 |
| Desal Recovery MOD | 99% | 50% | 50% |
| Inlet Seawater Flow MGD | 30.3 | 60.0 | 60.0 |
| Unscreened Estuary | 2 | 2 | 2 |
| Mitigation Area acre/MGD | | | |
| Impingement + Entrainment | 90% | 0% | 50% |
| Reduction % | | | |
| Estuary Mitigation Area acre | 6.1 | 120.0 | 60.0 |
| Annual Estuary Fresh Water | 10 | 10 | 10 |
| Requirement ft | | | |
| Annual Estuary Fresh Water | 19,697 | 390,000 | 195,000 |
| Requirement thousand | | | |
| gallons | | | |
| Estuary Ave Flow MGD | 0.05 | 1.07 | 0.53 |
| Waterfront Property % | 10% | 100% | 100% |

A typical system operation utilizing the teachings of the subject invention is as follows:

| | |
|---|---|
| Raceway Discharge Flow MGD | 30 |
| Raceway Discharge Flow ft3/s | 46.41 |
| Screen Diameter ft | 5 |
| Raceway Height - High Tide ft | 8 |
| Raceway Height - Low Tide ft | 7 |
| Raceway Width ft | 8 |
| Screen Cross flow Velocity at | |
| Raceway Discharge- | |
| High Tide ft/s | 1.05 |
| Low Tide ft/s | 1.28 |
| Screen Wire Width mm | 2.5 |
| Screen Opening Width mm | 0.5 |
| Screen Effective Area | 16.7% |
| % of total circumference | |
| Desal Inlet Flow MGD | 30 |
| Desal Inlet Flow ft3/s | 46.41 |
| Screen Slot Velocity ft/s | 0.5 |
| Screen Total Circumferential | 557.0 |
| Area ft2 | |
| Screen length ft | 35.5 |
| Intake Velocity | |
| Intake Flow MGD | 60 |
| Intake Flow ft3/s | 92.83 |
| Intake width ft | 8 |
| Intake depth ft | 20 |
| Intake Velocity ft/s | 0.58 |
| Outlet Velocity | |
| Outlet Flow MGD | 30 |
| Outlet Flow ft3/s | 46.41 |
| Outlet width ft | 8 |
| Outlet depth ft | 8 |
| Outlet Velocity ft/s | 0.72517 |
| Raceway Inlet Velocity | |
| High Tide ft/s | 1.45 |
| Low Tide ft/s | 1.66 |

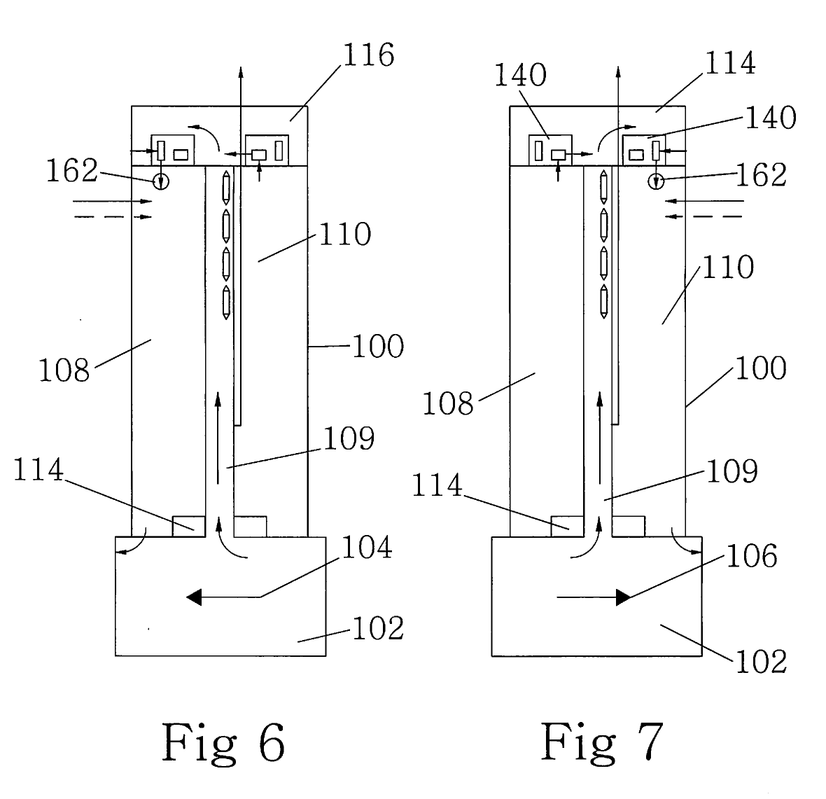

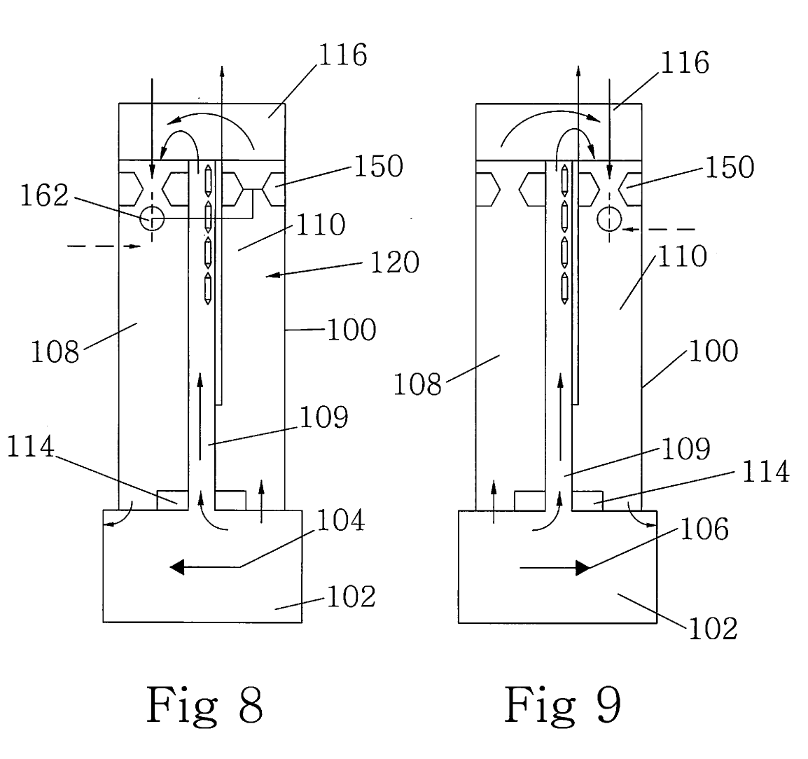

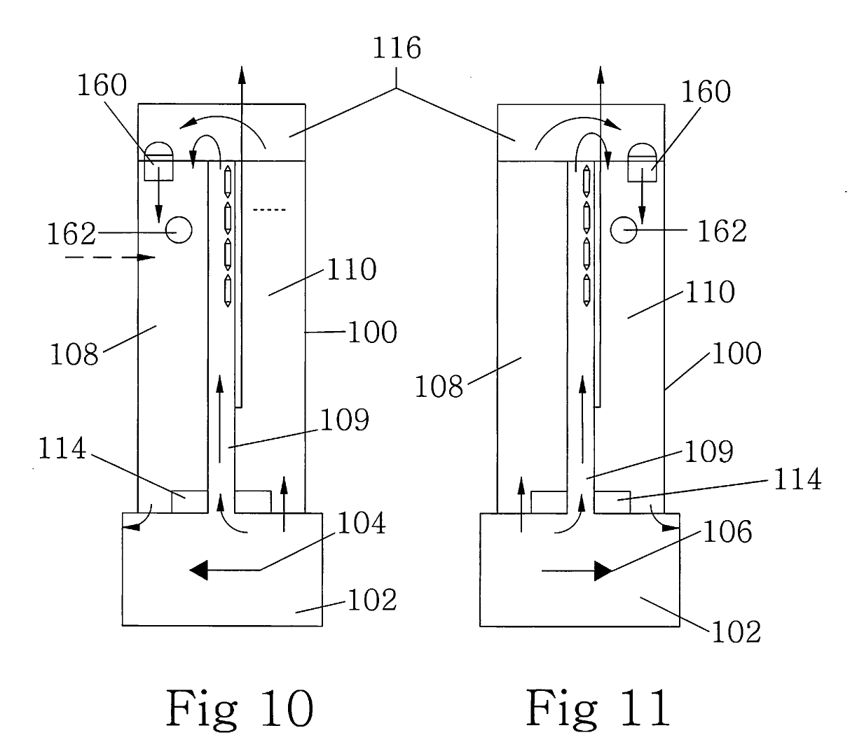

Alternative intake structures are shown in FIGS. 6-11. These structures are suitable alternatives to the system of FIGS. 3, 4 and 5, particularly when space availability is limited. FIGS. 6 and 7 depict a circulating intake structure incorporating a fish friendly pump. FIGS. 8 and 9 depict a circulating intake structure incorporating a Venturi pump. FIGS. 10 and 11 depict a circulating intake structure incorporating an airlift.

In all of the embodiments of FIGS. 6-11 a hollow, walled structure 100 is positioned in communication with a source of raw seawater 102. The arrows 104 and 106 designate flow during incoming tide (104) and outgoing tide (106). The structure 100 is subdivided into three chambers 108, 109 and 110. The intake chamber or column 109 receives raw seawater through the inlet port 112 at the rate of 60 MGD. A berm or box conduit 114 divides the raw seawater 102 from the oyster reefs housed in chambers 108 and 110.

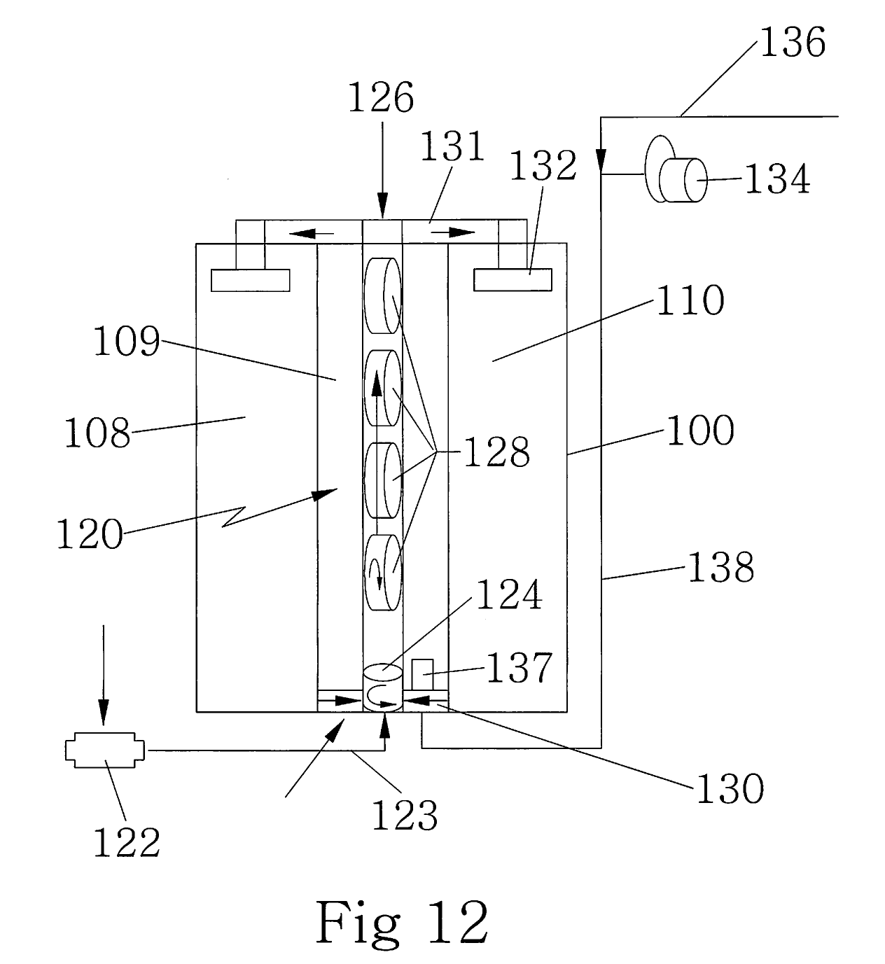

Each of the embodiments of FIGS. 6-11 incorporate the low head recirculating system 120 shown in more detail in FIG. 12. In FIGS. 6 and 7 a fish pump system 122 is utilized in combination with the low head recirculating system 120. In FIGS. 8 and 9 a Venturi pump system 124 is utilized in combination with the low head recirculating system 120. In FIGS. 8 and 9 an airlift system 126 is utilized in combination with the low head recirculating system 120.

With specific reference to FIG. 12, the low head recirculating system 120 is housed in the intake chamber 109. An inlet pipe 123 introduces fresh water from the fresh water supply 122 into a microscreen drum filter 124. The water is then passed through a biofilter vessel 126 which includes a plurality of inline biofilters 128. The filtered water then passes through pipeline 131 into the airlift header 132, and from there through chambers 109 to the discharge pipe 137. Air lines 136 are in communication with a regenerative blower 132 for providing a vacuum in line 138 for drawing the biofiltered water through the discharge pipe 137. When used in connection with the Venturi pump configuration of FIGS. 8 and 9 the low head recirculating system 120 provides a low head circulating system which supports a high rate of fish transfer without upflow or aeration and is commercially proven technology. When in connection with the airlift system of FIGS. 10 and 11 the low head circulating system 120 provides a system that does not require any moving parts, is gentle on fish, aerates and circulates the water and is commercially proven technology.

FIGS. 6 and 7 show an embodiment of the subject invention using the low head circulating system 120 in combination with a fish friendly pump 140. One example of a fish friendly pump is the WEMCO Hidrostal Pump which has been shown to provide up to 97% fish/larvae survival rate. In this configuration the screened seawater from the low head circulating system 120 is introduced into chamber 116 and passed through the fish friendly pump 140 and into the discharge chambers 108, 110. FIG. 6 shows incoming tide operation. FIG. 7 shows outgoing tide operation. This system circulates water by intake screens and provides a cross-current of up to 2 ft/s which enables escape for larvae. The pumps 140 circulate the water, providing a large entrainment ratio, with low head and gentle suction flow minimizing larvae destruction. The system supports reef flow and aerates the seawater. Utilizing alternate discharges based on tide flow assures discharge is always on the downstream of intake and prevents re-ingestion of larvae rich reef water.

The Venturi pump system of FIGS. 8 and 9 incorporates the Venturi pumps 150 into a system utilizing the low head circulating system 120. As in FIGS. 6 and 7, the system includes an incoming tide configuration (FIG. 8) and an outgoing tide configuration (FIG. 9), again utilizing alternate discharges based on tide flow assures discharge is always on the downstream of intake and prevents re-ingestion of larvae rich reef water. The Venturi pump configuration circulates the water by intake screens and provides a cross-current of up to 2 ft/s which enable escape for larvae. An educator circulates the water with a large entrainment ration of approximate 10:1. The system generates a gentle suction flow which minimizes larvae destruction. The system mixes desal, seawater and air, providing a sweep flow for the oyster reef.

The airlift system 160 incorporated in FIGS. 10 and 11 also includes an incoming tide configuration (FIG. 10) and an outgoing tide configuration (FIG. 11), again utilizing alternate discharges based on tide flow assures discharge is always on the downstream of intake and prevents re-ingestion of larvae rich reef water. The airlift configuration circulates the water by intake screens and provides a cross-current of up to 2 ft/s which enable escape for larvae. The system circulates the water with a large entrainment ration of approximate 10:1. The system generates a gentle suction flow which minimizes larvae destruction. The system mixes desal, seawater and air, providing a sweep flow for the oyster reef.

It will be noted that each of the systems depicted in FIGS. 6-11 include a port 160 for introduction of brackish desal during normal operation.

All of the configurations of FIG. 6-12 minimize entrainment and entrapment losses, permit operation of the reef at optimum conditions, provide a system which is a net producer of larvae, require minimal waterfront space use and minimize or eliminate obstructions to navigation.

### Alternate Embodiment with Raceway above Sea Level

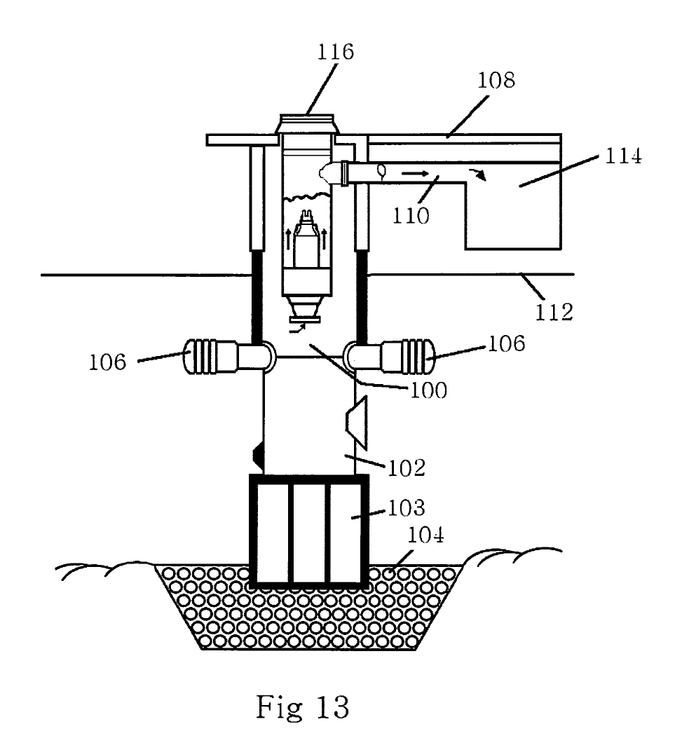

As shown in FIG. 13, for some locations it may be desirable to locate the inlet raceway above sea level in order to avoid excessive excavation or reduce the chance of flooding during hurricanes or storm surges. In this embodiment a submersible fish friendly pump 100 is located inside a partially submerged vertical pipe 102, supported on the sea bottom 104, equipped with intake gratings 106 (FIG. 13). The vertical pipe and fish friendly pump assembly is submerged in a concrete tube 103. The submerged pipe and pump are located underneath an elevated pier or dock structure 108. A horizontal pipe 110, above sea level 112 running underneath or on top of the dock is connected to the vertical pipe 102. Water is pumped from the submerged fish friendly pump 100 up the vertical partially submerged pipe 102 to the elevated horizontal pipe 110 that runs the length of the dock. The horizontal pipe directs the pumped seawater to the raceway 114. An access cover 116 may be provided on the pier 108 for gaining access to the pump 100 in the vertical pipe 102. This configuration permits an installation that minimizes excavation and further, reduces the chance of flooding during hurricanes or storm surges.

The elevated pipe 110 discharges into a raceway 114 that is located above sea level. The raceway is sloped, causing the seawater to flow by gravity down the raceway at 1-2 ft/s. Wedgewire screens are located in the raceway, and a portion of the seawater is pulled through the screens to feed the desal unit as described in the earlier embodiments. The water remaining in the raceway downstream of the screens is directed into two above sea level reef sections (not shown) located on either side of the raceway which redirect the non-screened seawater back to the sea.

The non-screened seawater containing approximately 90% of the sea life flows by gravity through each reef section. Typically, the discharge of each reef section has a valve and a short downward sloped outlet pipe. The outlet valves are controlled based on tidal flows so that the reef outlet water is not reingested back into the inlet pump. Generally, the outlet valve that is on the downstream tidal flow side of the inlet pipe is opened, and the upstream valve is closed. The short sloped outlet pipes from each reef are designed to gently reintroduce the reef sea life back into the sea without allowing large predators to enter the reefs.

While certain features and embodiments have been described in detail herein, it should be understood that the invention encompasses all modifications and enhancements with the scope and spirit of the following claims.

I claim:

1. A seawater intake system for providing seawater to a desalination plant having an intake for receiving seawater, comprising:
a. A first filtering system in communication with raw seawater for providing a flow of seawater in a first direction;
b. A second filtering system in communication with the first filtering system for receiving the seawater passing therethrough;
c. A subsystem for drawing a portion of the seawater through the second filtering system for producing filtered seawater;
d. A reef bed;
e. A transfer system for delivering a residual portion of the second filtered seawater to the reef bed.

2. The seawater intake system of claim 1, wherein the first filter system is a microscreen drum filter.

3. The seawater intake system of claim 1, wherein the second filter system is a biofilter.

4. The seawater intake system of claim 1, wherein the second filter system is a series of inline biofilters.

5. The seawater intake system of claim 1, wherein the subsystem is a fish pump.

6. The seawater intake system of claim 1, wherein the subsystem is a Venturi pump.

7. The seawater intake system of claim 1, wherein the subsystem is an airlift system.

8. A seawater intake system for providing seawater to a desalination plant having an intake for receiving seawater, comprising:
a. A first filtering system in communication with raw seawater for providing a flow of seawater in a first direction;
b. A second filtering system in communication with the first filtering system for receiving the seawater passing therethrough;
c. A fish pump for drawing a portion of the seawater through the second filtering system for producing filtered seawater;
d. A reef bed;
e. A transfer system for delivering a residual portion of the second filtered seawater to the reef bed.

9. A seawater intake system for providing seawater to a desalination plant having an intake for receiving seawater, comprising:
a. A first filtering system in communication with raw seawater for providing a flow of seawater in a first direction;
b. A second filtering system in communication with the first filtering system for receiving the seawater passing therethrough;
c. A Venturi pump for drawing a portion of the seawater through the second filtering system for producing filtered seawater;
d. A reef bed;
e. A transfer system for delivering a residual portion of the second filtered seawater to the reef bed.

10. A seawater intake system for providing seawater to a desalination plant having an intake for receiving seawater, comprising:
a. A first filtering system in communication with raw seawater for providing a flow of seawater in a first direction;
b. A second filtering system in communication with the first filtering system for receiving the seawater passing therethrough;
c. An airlift system for drawing a portion of the seawater through the second filtering system for producing filtered seawater;
d. A reef bed;
e. A transfer system for delivering a residual portion of the second filtered seawater to the reef bed.

11. A seawater intake system for providing seawater to a desalination plant having an intake for receiving seawater, comprising:
a. A micro screen drum filter in communication with raw seawater for providing a flow of seawater in a first direction;
b. A biofilter system in communication with the first filtering system for receiving the seawater passing therethrough;
c. A subsystem for drawing a portion of the seawater through the second filtering system for producing filtered seawater;
d. A reef bed;
e. A transfer system for delivering a residual portion of the second filtered seawater to the reef bed.

12. The seawater intake system of claim 11, wherein the biofilter system comprises a plurality of inline biofilters in series.

13. A seawater intake system for providing seawater to a desalination plant having an intake for receiving seawater, comprising:
a. A conduit extending from a point above sea level into the seabed;
b. A fish friendly pump in the conduit and partially submerged below sea level;
c. an opening in the pipe wall below sea level for permitting seawater to flow into the pipe and into contact with the fish friendly pump;
d. an outlet pipe above sea level and in communication with the interior of the conduit for receiving seawater pumped into the conduit by the fish friendly pump.
e. a raceway for positioned above sea level and in communication with the outlet pipe for receiving seawater flowing therein.

14. The seawater intake system of claim 13, wherein the opening in the pipe wall includes a filter for filtering raw seawater.

15. The seawater intake system of claim 14, wherein the filter comprises a mechanical grating.

16. The seawater intake system of claim 13, further including a pier positioned above the sea level and wherein the pipe extends through the pier.

17. The seawater intake system of claim 16, wherein the portion of the pipe extending through the pier is open-ended and there is further including a removable cap on the open end of the pipe.

18. The seawater intake system of claim 16, further including a walled casing extending from the pier to the seabed for housing the vertical pipe and the fish friendly pump.
